(19) United States
(12) Patent Application Publication
(10) Pub. No.: US 2023/0307929 A1
(43) Pub. Date: Sep. 28, 2023

(54) HOLDING AND CHARGING APPARATUS FOR A PORTABLE ELECTRONIC DEVICE

(71) Applicant: Bunker Supply Co., LLC., Goleta, CA (US)

(72) Inventors: Ryan Russell Olson, Goleta, CA (US); Jared Ryan Naito, Santa Barbara, CA (US); Marco Antonio Jose Vanella, Goleta, CA (US)

(21) Appl. No.: 18/063,342

(22) Filed: Dec. 8, 2022

Related U.S. Application Data
(60) Provisional application No. 63/324,560, filed on Mar. 28, 2022.

(51) Int. Cl. H02J 7/00; A45C 11/00

(52) U.S. Cl. CPC H02J 7/0044; H02J 7/0045; A45C 11/00; A45C 2011/003; H02J 7/342

(57) ABSTRACT

A pouch for a portable electronic device includes an adjustable receptacle for receiving the portable electronic device. The adjustable receptacle includes a plurality of flaps. The plurality of flaps includes, one or more side flaps, a main flap, and a retention flap. The main flap comprises a first segment and a second segment and the second segment is pivotably attached to the first segment. Moving the adjustable flaps relative to each other changes a size of the adjustable receptacle.

### CROSS-REFERENCE TO RELATED APPLICATION

This application claims the benefit of U.S. Provisional Application No. 63/324,560, filed Mar. 28, 2022. The prior application is incorporated by reference in its entirety.

### FIELD

This disclosure relates to holding and charging apparatus for portable electronic devices.

### BACKGROUND

Many portable electronic devices, such as mobile telephones, have a rechargeable battery. In some use cases, a user can attach the device to an electrical outlet via a charging cord or a wireless charging device. In certain situations, however, access to an electrical outlet is not practical. As such, access to auxiliary power and/or charging devices is needed.

Portable electronic devices may also need to be protected and/or secured to user. The protected portable electronic device should also allow easy access to the device.

As such, there is a need for improved devices that allow a portable electronic device (e.g., a mobile phone) to be connected to an auxiliary power source (e.g., an external battery), that protects and secures the device to a user, and that allows the user to easily access the device.

### SUMMARY

Aspects and advantages of the disclosed technology will be set forth in part in the following description, or may be obvious from the description, or may be learned through practice of the technology disclosed in the description.

In some examples, a pouch for a portable electronic device comprises an adjustable receptacle for receiving the portable electronic device. The adjustable receptacle comprises a plurality of flaps. The plurality of flaps comprises, one or more side flaps, a main flap, and a retention flap. The main flap comprises a first segment and a second segment and the second segment is pivotably attached to the first segment. Moving the adjustable flaps relative to each other changes a size of the adjustable receptacle.

In some examples, the pouch further comprises a battery holding portion configured for receiving a battery therein.

In some examples, the battery holding portion comprises a retention feature therein configured for securing an external battery therein.

In some examples, the pouch comprises a panel with a wireless charging locator.

In some examples, the pouch further comprises one or more straps capable of being connected to an external substrate.

In some examples, the battery holding portion contains outward facing windows.

In some examples, a pouch for a portable electronic device comprises an adjustable receptacle for receiving the portable electronic device. The adjustable receptacle comprises a plurality of flaps adjustable coupled together. Moving the adjustable flaps relative to each other changes a size of the adjustable receptacle and/or a retention force on the portable electronic device.

In some examples, the pouch further comprises a battery holding portion configured for receiving a battery therein.

In some examples, the battery holding portion comprises a retention feature therein configured for securing an external battery therein.

In some examples, the pouch comprises a panel with a wireless charging locator.

In some examples, the pouch comprises a panel with a battery level window.

In some examples, the battery holding portion contains outward facing windows.

In some examples, an assembly comprises a pouch and an external battery. The pouch comprises an adjustable receptacle and a battery holding portion, and the adjustable receptacle is configured for receiving a portable electronic device. The external battery is configured to be releasably secured within the battery holding portion of the pouch.

In some examples, the assembly further comprises a case for a portable electronic device.

In some examples, the external battery comprises a pull tab configured for removing the external battery from the pouch.

In some examples, the assembly further comprises a portable electronic device.

In some examples, the portable electronic device is a mobile phone.

In some examples, the adjustable receptacle comprises a plurality of flaps, and the plurality of flaps comprises, one or more side flaps, a main flap, and a retention flap.

In some examples, the battery holding portion of the pouch comprises a projection configured for mating with a recess of the external battery.

In some examples, the pouch comprises a panel with a wireless charging locator.

These and other features, aspects, and/or advantages of the present disclosure will become better understood with reference to the following description and the claims. The accompanying drawings, which are incorporated in and constitute a part of this specification, illustrate examples of the disclosed technology and, together with the description, serve to explain the principles of the disclosure.

### BRIEF DESCRIPTION OF THE DRAWINGS

FIG. 1 is a front view of a holding and charging apparatus for a portable electronic device, according to one example.

FIG. 2 is a back view of the holding and charging apparatus for a portable electronic device of FIG. 1.

FIG. 3 is a first side view of the holding and charging apparatus for a portable electronic device of FIG. 1.

FIG. 4 is a second side view of the holding and charging apparatus for a portable electronic device of FIG. 1.

FIG. 5 is a top view of the holding and charging apparatus for a portable electronic device of FIG. 1.

FIG. 6 is a bottom view of the holding and charging apparatus for a portable electronic device of FIG. 1.

FIG. 7 is an exploded view of the holding and charging apparatus for a portable electronic device of FIG. 1, depicting the primary components of the apparatus.

FIG. 8 is a perspective view of the holding and charging apparatus for a portable electronic device of FIG. 1, depicting a retention feature of the pouch configured to retain the battery therein.

FIG. 9 is a perspective view of the holding and charging apparatus for a portable electronic device of FIG. 1, depicting a battery pull tab feature of the pouch configured to aid in the removal of the battery from the apparatus.

FIGS. 10A-B are perspective views of the holding and charging apparatus for a portable electronic device of FIG. 1, depicting pull tab features configured to aid in accessing/opening the pouch to access the portable electronic device.

FIG. 11 is a perspective view of the holding and charging apparatus for a portable electronic device of FIG. 1, depicting the apparatus in an open state.

FIG. 12 is a first side view of the holding and charging apparatus for a portable electronic device of FIG. 1, depicting the apparatus in an open state.

FIG. 13 is a front view of the holding and charging apparatus or a portable electronic device of FIG. 1, depicting the apparatus in an open state.

FIG. 14 is second side view of the holding and charging apparatus for a portable electronic device of FIG. 1, depicting the apparatus in an open state.

FIGS. 15A-15G depict an exemplary method of positioning and securing a portable electronic device to the holding and charging apparatus for a portable electronic device of FIG. 1.

### DETAILED DESCRIPTION

General Considerations

For purposes of this description, certain aspects, advantages, and novel features of the examples of this disclosure are described herein. The disclosed methods, apparatuses, and systems should not be construed as limiting in any way. Instead, the present disclosure is directed toward all novel and nonobvious features and aspects of the various disclosed examples, alone and in various combinations and sub-combinations with one another. The methods, apparatuses, and systems are not limited to any specific aspect or feature or combination thereof, nor do the disclosed examples require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially (e.g., assembly or disassembly of an apparatus) may in some cases be rearranged or performed concurrently. Moreover, for the sake of simplicity, the attached figures may not show the various ways in which the disclosed methods can be used in conjunction with other methods. As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C,” or “A, B, and C.”

As used herein, the term “coupled” generally means physically coupled or linked. Two components that are coupled to each other can be directly connected to each other or can be indirectly connected to each other with one or more intermediate elements between the coupled items.

As used herein, the term “integrally formed” generally means formed as a unitary structure. Two of more components can be integrally formed, for example, by machining the components as a unitary structure from a single piece of material. Two of more components can be integrally formed, for example, by welding two components together to form a unitary structure.

Examples of the Disclosed Technology

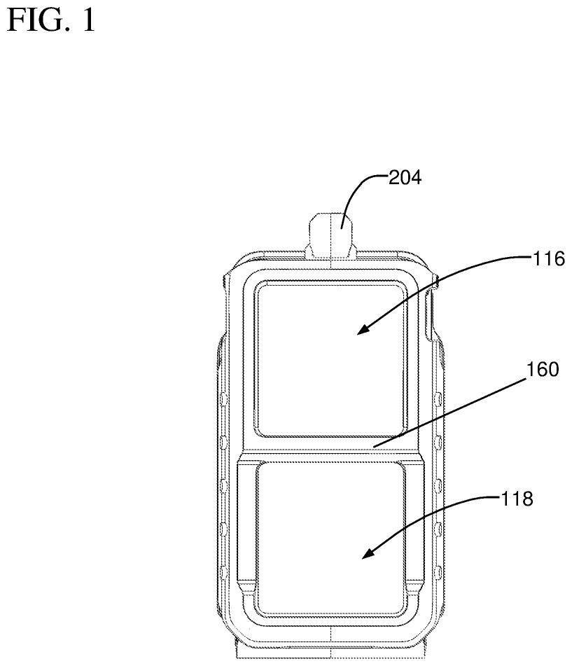

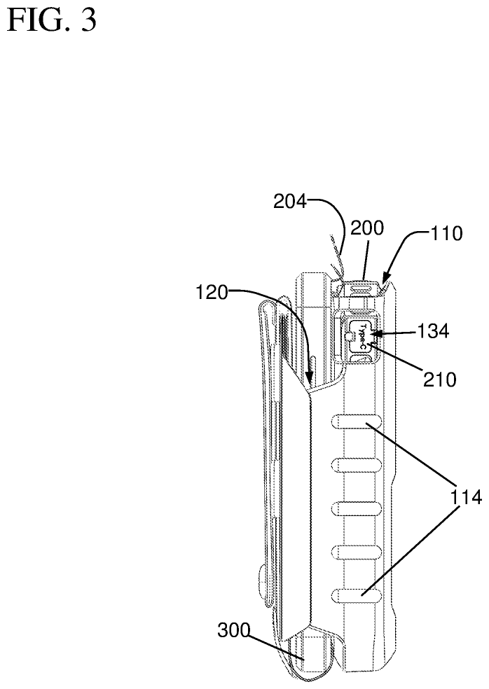

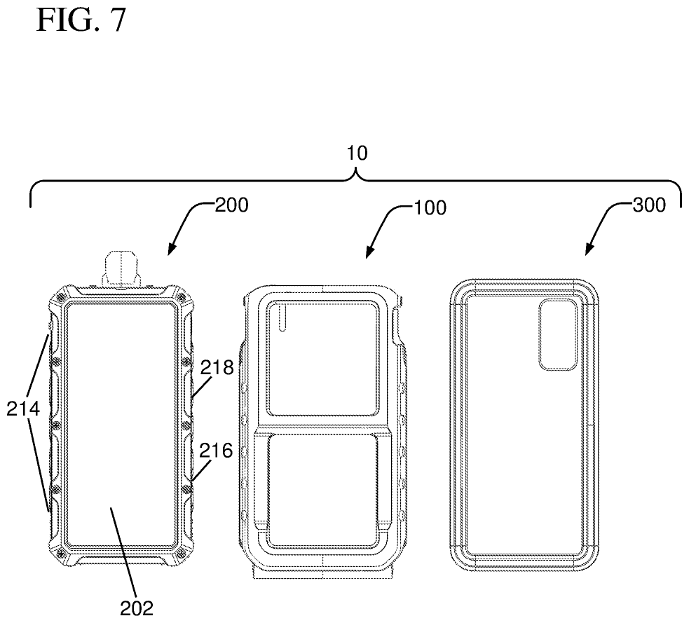

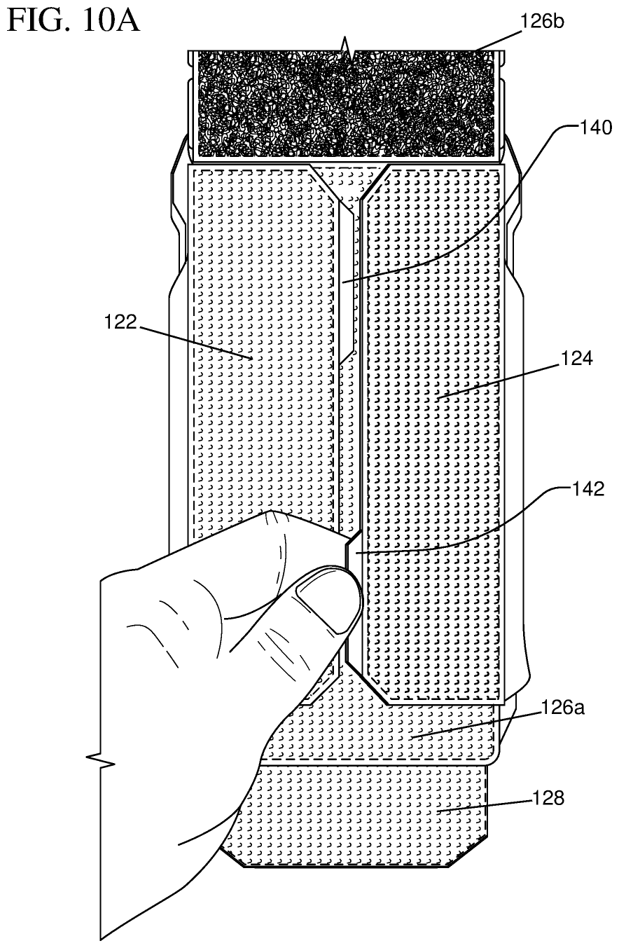

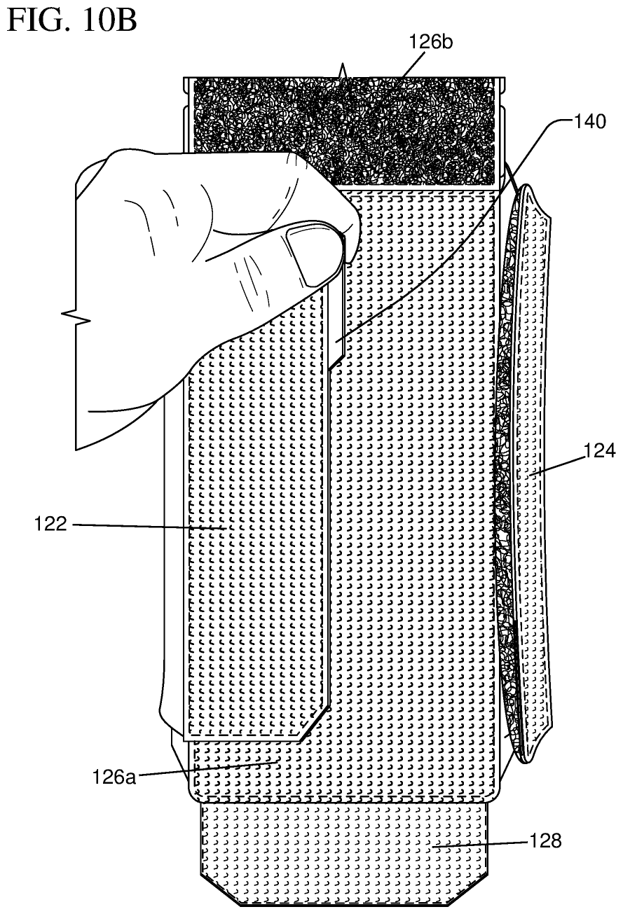

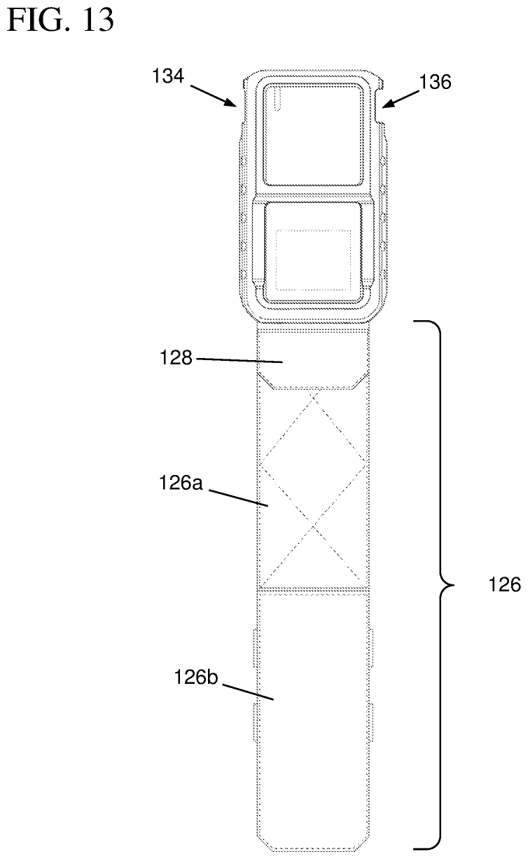

FIGS. 1-15G depict a holding and charging apparatus 10 for a portable electronic device, according to one example. As shown in FIG. 7, the apparatus 10 comprises three main components: a pouch 100, a battery 200, and a case 300 for the portable electronic device. It should be noted that a portable electronic device can, for example, include a mobile telephone (e.g., cellular phone, satellite phone, etc.).

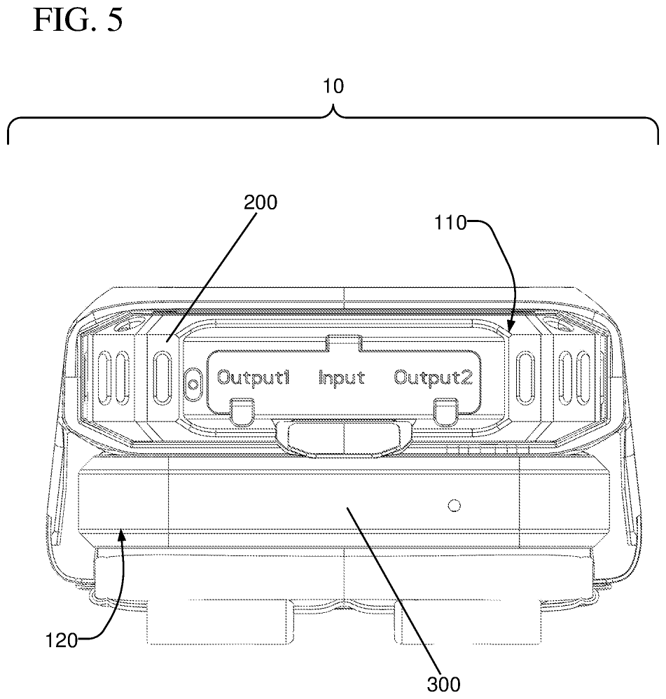

Referring to FIG. 5, the pouch 100 of the apparatus 10 comprises two main portions: a battery holding portion 110 for the battery 200 and a device receptacle portion 120 for a device such as the phone case 300, phone, and/or another portable electronic device.

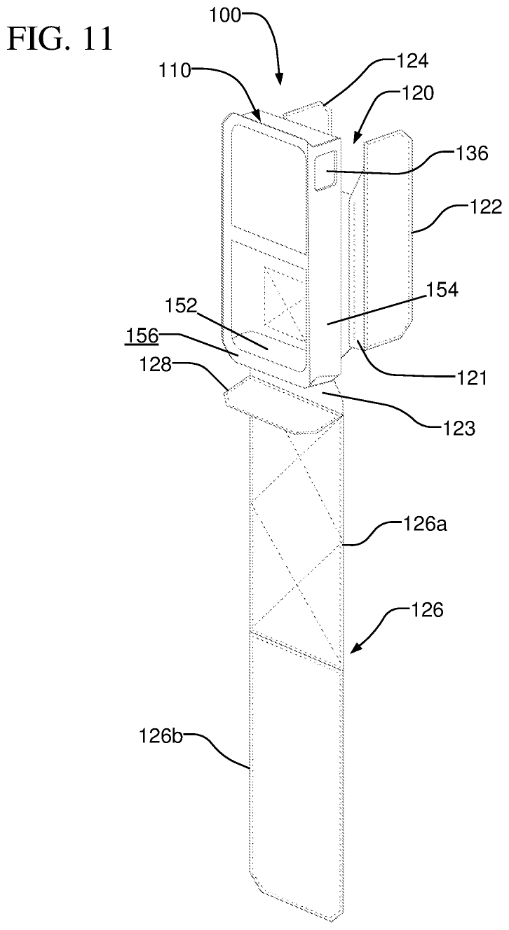

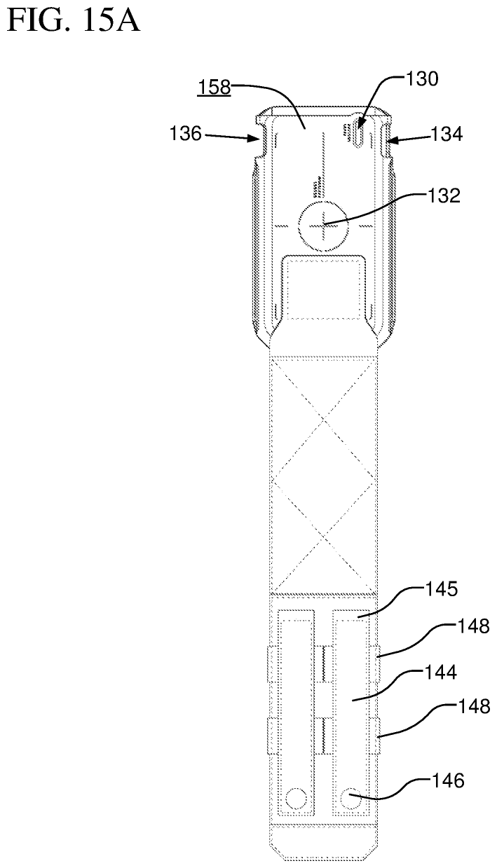

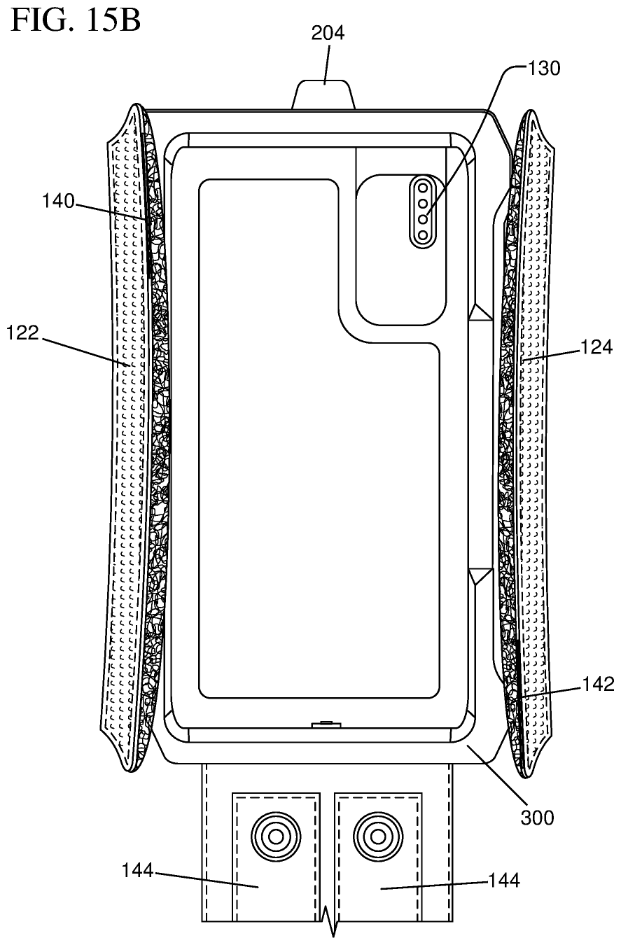

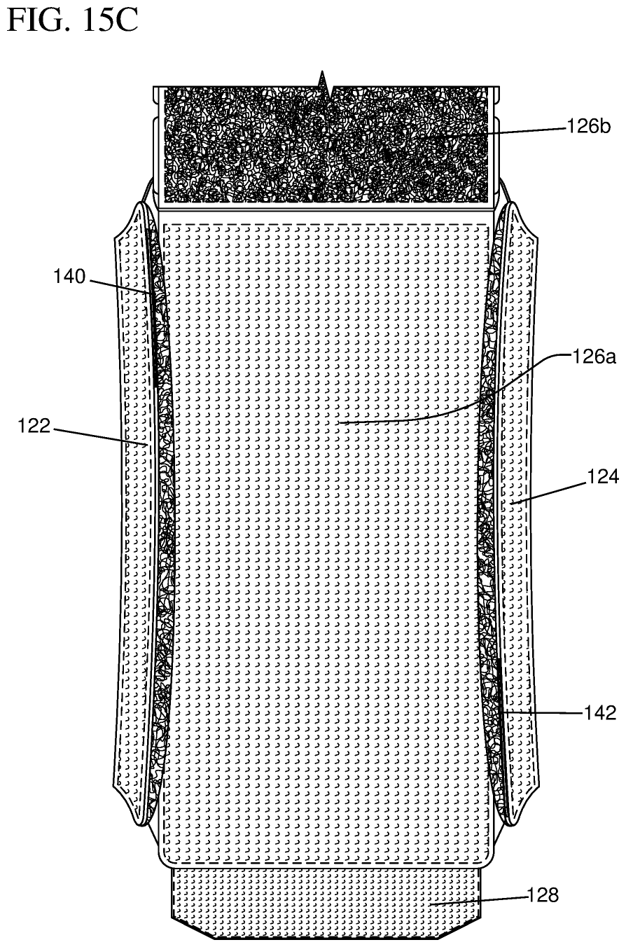

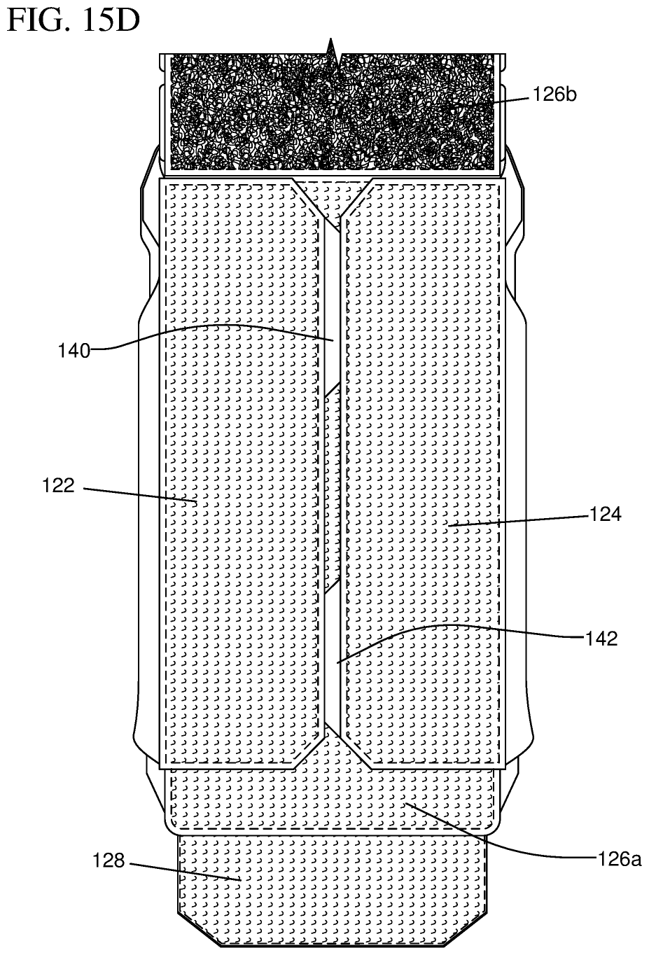

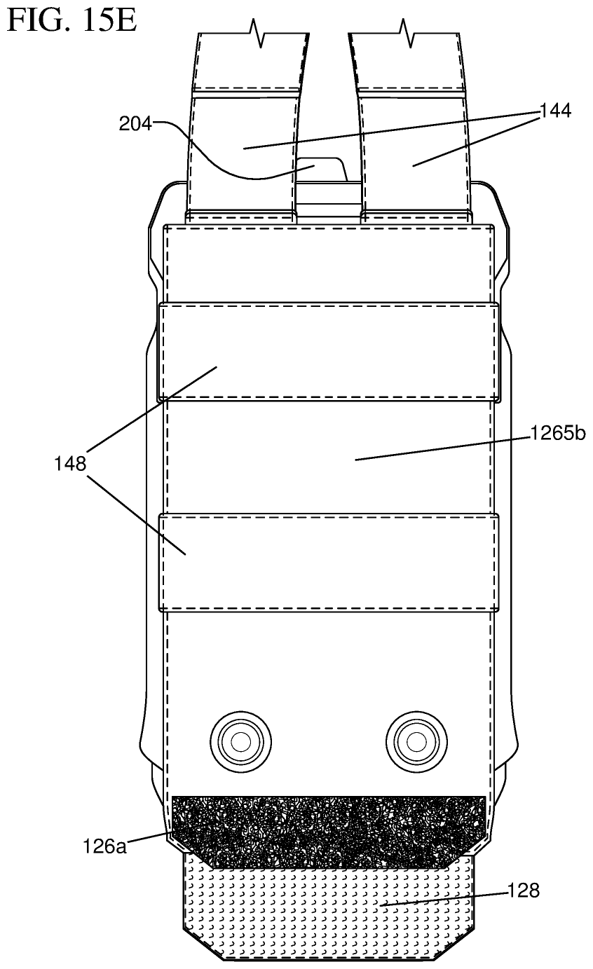

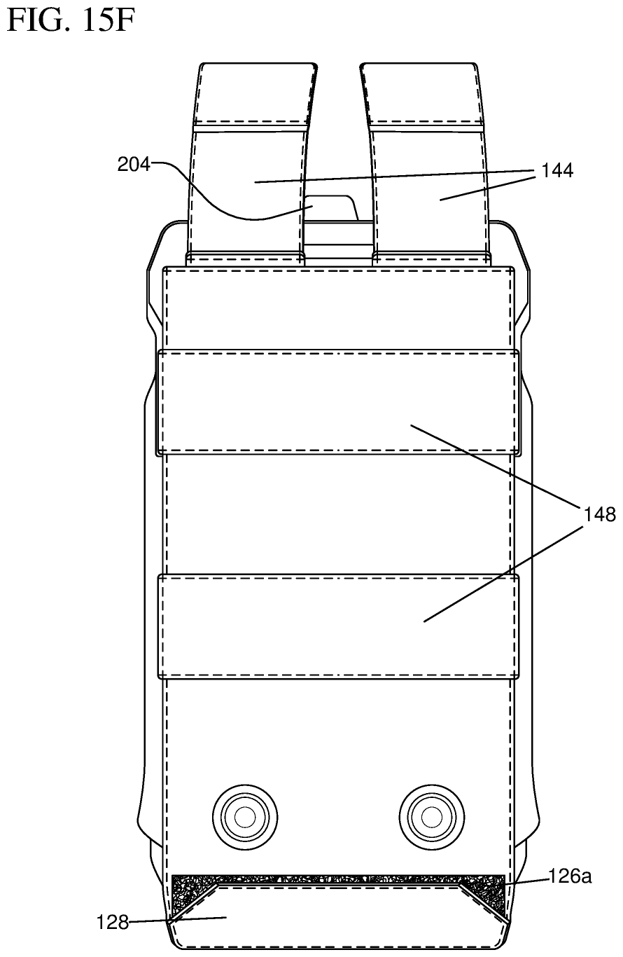

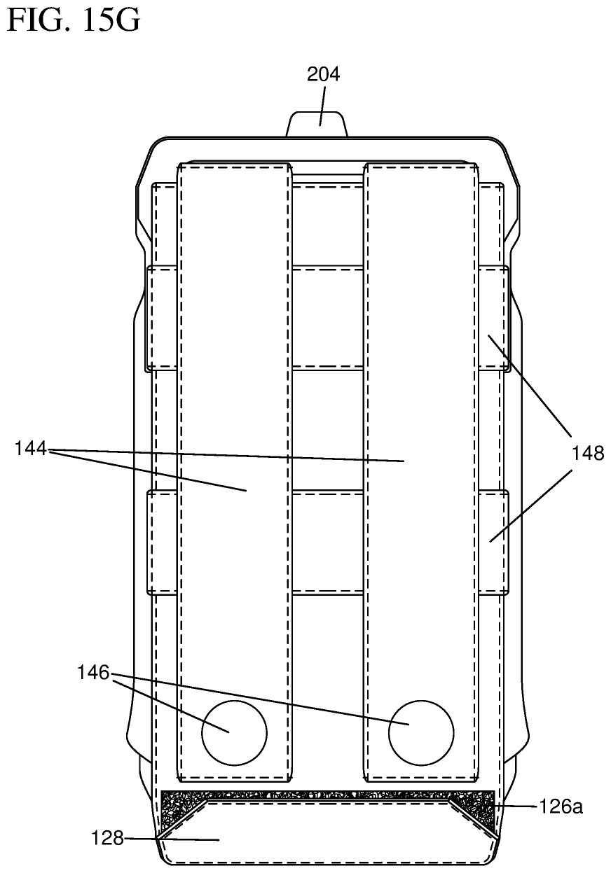

The battery holding portion 110 is designed to retain the battery 200 while also providing protection from environmental hazards as well as from bumps and shocks. Referring to FIG. 11, the battery holding portion 110 comprises a plurality of surfaces and walls which together form a receptacle for the battery 200. In some examples, these walls can include an end wall 152 and two opposing side walls 154 extending from the end wall as well as a front plane surface 156 and a back plane surface 158 (FIG. 15A) which are substantially parallel to one another, as used herein substantially parallel means within +/−5% and substantially perpendicular to the end wall 152 and the two side walls 154, as used herein substantially perpendicular means within +/−5%. Substantially parallel and substantially perpendicular are defined so as to account for manufacturing processes, e.g., draft angles used in molding.

The battery holding portion 110 is configured to receive and retain the battery 200 and can be constructed of a rigid, semi-rigid, or flexible material. The battery holding portion 110 can be formed of various material, including polymeric materials. In one example, the battery holding portion 110 is made of a thermoplastic elastomer (TPE), e.g., thermoplastic polyurethane (TPU). Various other materials can be used including other polymeric materials and/or non-polymeric materials.

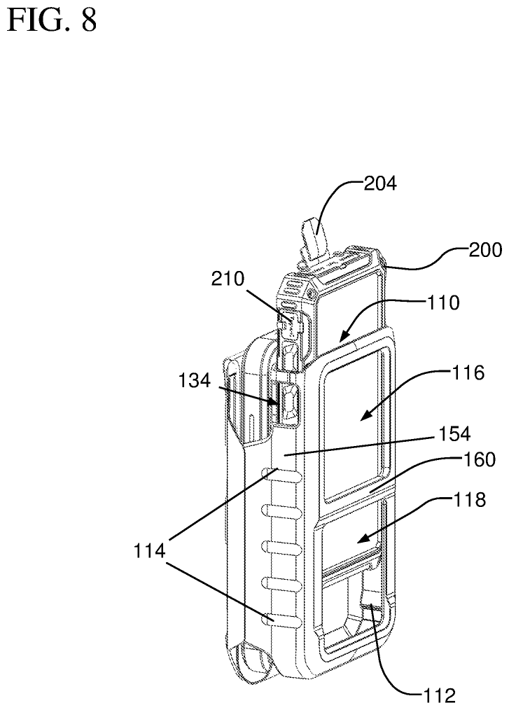

Referring to FIG. 8, the battery holding portion 110 can comprise one or more retention features configured to engage with the battery 200 to help secure the battery within the battery holding portion. The retention features can include mating (e.g., male/female), snap-fit, friction, and/or other features configured to secure the battery within the battery holding portion of the pouch. In the depicted example, the battery holding portion comprises one or more projections 112 configured to mate with a corresponding recess disposed on a side portion of the battery 200. The one or more projections 122 can be located on one or both side walls 154 and the structure of the battery holding portion can deform to allow removal of the battery. The retention force can exceed the forces typically experienced during use of the system, thereby preventing inadvertent removal of the battery.

Referring still to FIG. 8, in some examples, outside surfaces of the side walls 154 can have one or more friction enhancing elements. These friction enhancing elements are configured to improve the user's grip on the apparatus 10. In the depicted example the friction enhancing elements are recesses 114, which are oblong in shape. The shape and/or size of the recesses may vary. The sidewalls can comprise one or more other friction enhancing elements in lieu of or in addition to the recesses 114, such as surface texturization, projections, coatings, etc. The friction enhancing elements can comprises various shapes and/or sizes.

The battery 200 may also have numerous features which will be described in greater detail below. It is desirable that the battery holding portion is configured to not interfere with the user's ability to interact with or make use of these features.

One potential battery feature is the ability to charge by sunlight using solar panels. As worn by the user, the battery holding portion 110 is on the outwardly facing side of the pouch 100 (e.g., the front). The front plane surface 156 can comprise one or more apertures configured to expose the solar panels of the battery 200 to light. In some instances, the one or more apertures can be open on one side to create a “U” shape. In other instances, the one or more apertures can comprise one or more windows. The windows of the battery holding portion 110 can be separated by one or more frame members. These frame members can help retain the battery 200 within the battery holding portion 110 and/or provide structural stability to the battery holding portion 110. The depicted example comprises two windows (i.e., a first window 116 and a second window 118) separated by a frame member 160.

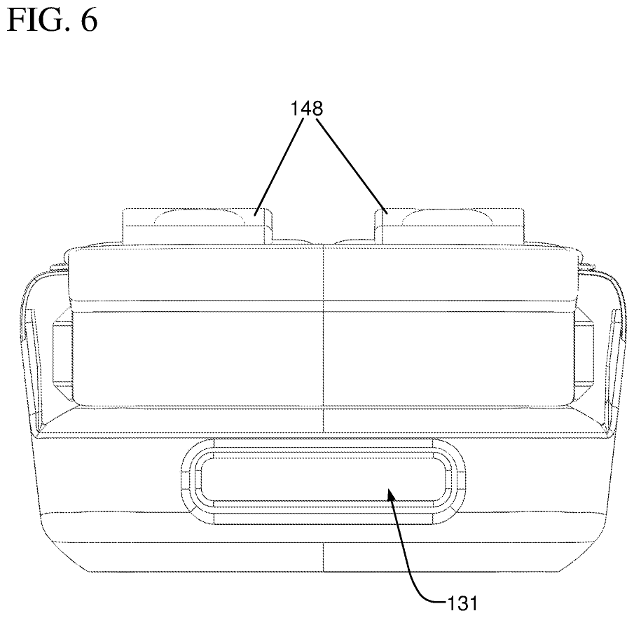

Another potential battery feature is a flashlight affixed to the outer surface of the battery. It is desirable to allow the user to make use of this flashlight feature while the battery 200 is inserted into the battery holding portion. Referring to FIG. 6, in some instances the battery holding portion 110 can have a flashlight opening 131 which corresponds to a flashlight 206 of the battery 200. The flashlight opening 131 may be configured to have different shapes which correspond to the shape of a flashlight 206 on the battery 200. In some instances, the flashlight opening 131 is rectangular with rounded edges.

Another feature of the battery is that it may contain various indicators and/or readouts for passing information to the user. Referring now to FIG. 15A, the pouch 100 can comprise one or more additional features directed to these indicators or readouts on the battery 200. For example, windows which allows the one or more indicators on the battery 200 to be visible. In one instance, the back plane surface 158 contains a battery level window 130 that can allow a battery level indicator on the battery 200 to be visible. In other instances, other windows in the pouch 100 can be present.

The outer surface of the back plane surface 158 can also comprise a wireless charging indicator that can aid in aligning the induction coil of the portable electronic device with the induction coil of a wireless battery. In one example, illustrated in FIG. 15A this wireless charging indicator 132 takes the form of two segmented, perpendicular intersecting lines and a circle centered on the interception of the lines. In other examples, different wireless charging indicators can be used which comprise different combinations of lines and/or shapes.

In a field setting, it is desirable that the battery 200 can be connected to a wide variety of different cables. In some instances, the battery 200 may consist of one or more ports for various connections to be made to the battery 200. The battery holding portion 110 may also comprise access openings as shown in FIG. 8. In some examples, one or more access openings may be provided for one or more ports in the battery 200. In one example, a USB-C port access opening 134 is provided. In other examples, other connection types such as mini USB, micro USB, lightning connectors and/or a similar connection may be used.

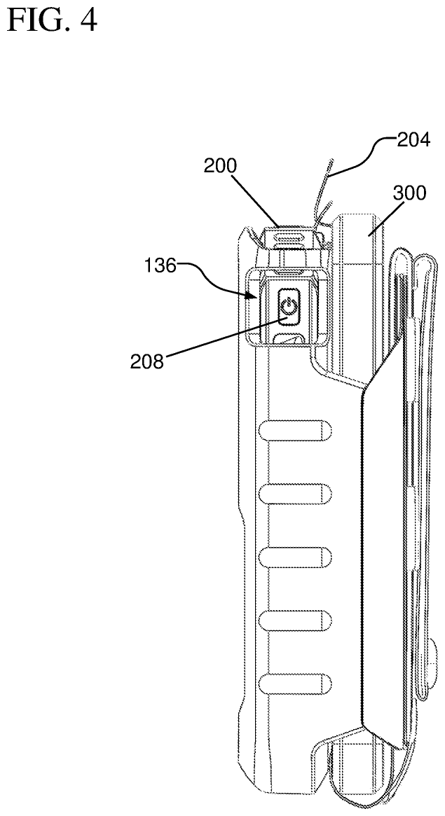

The battery 200 may include one or more battery control interfaces. The battery holding portion 110 may also comprise access windows in the battery holding portion for user access to these battery control interfaces. In one example, a power button window 136 is provided for user access to the battery power button 208, as depicted in FIG. 4. In other examples, a variety of other access windows may be provided for access to other battery control interfaces.

Referring to FIG. 11, the pouch 100 also comprises a device receptacle portion 120 for the phone case and/or phone. This device receptacle portion 120 is adjustable by the user to fit a variety of different electronic devices and is made up of a plurality of flaps which have one edge fixedly attached to the battery holding portion 110 and which are attachable to one another to form a cavity for the electronic device. The adjustable flaps also provide the user with the ability to adjust the retention force on the portable electronic device to allow the device to be more or less secure or more or less easily accessible based on the user's preference. The pouch 100 is adjustable to accommodate a wide range of phones and/or phone cases such that the phone will be both secured within the pouch and aligned with the wireless charging unit of the battery. The flaps may be constructed of nylon, polyester, cotton, or similar materials, or a combination of different materials, in one example the flaps are made of ballistic 1000D nylon, in other examples the flaps are made of Hypalon or a combination of ballistic 1000D nylon and Hypalon, in other cases they are made from 1000D/500D laminate fabric, or other textile-based materials.

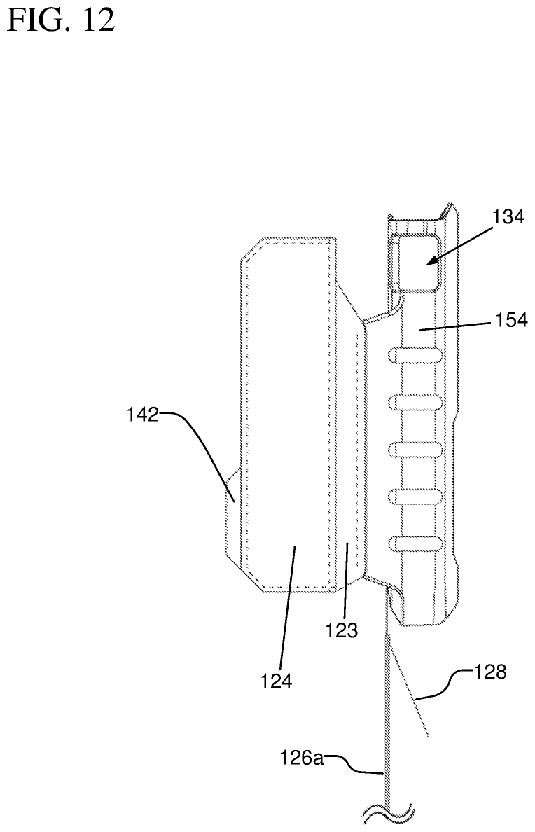

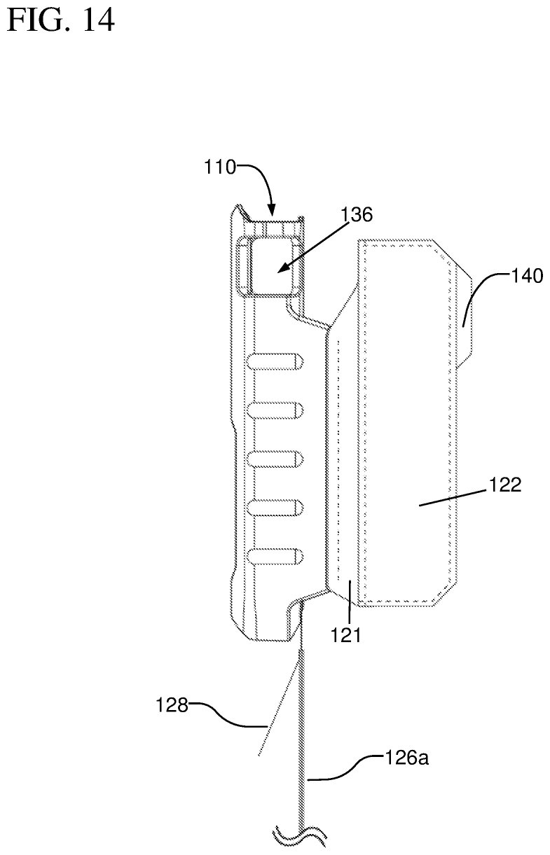

The flaps are configured to be secured to one another using a securing mechanism such as hook and loop, snap fit, or other similar mechanisms. Referring still to FIG. 11, in one example, the plurality of flaps includes a first side flap 122; a second side flap 124; a main flap 126, which has a first segment 126a and a second segment 126b which are pivotably connected to each other; and a retention flap 128. In the example referred to above, the flaps have hook and loop fastener attached in a way configured to connect the flaps together to form the device receptacle portion 120. As depicted, the device receptacle portion can be easily adjusted to various devices and can wrap around the device. As shown in FIG. 12 and FIG. 14, in some examples there may be additional spacer segments 121, 123 between the various flaps and the battery holding portion 110 to aid in creating a cavity of the proper shape to receive the electronic device.

Various flaps, wings, etc. that form the device receptacle portion can comprise mechanisms which make the flaps, wings, etc. easier for the user to manipulate. In one example the mechanism comprises pull tabs configured for manipulating the components. For example, FIG. 12 and FIG. 14 depict pull tabs 140, 142 on the side wings of the device receptacle portion 120 of the pouch 100. In other examples, the mechanism can comprise loops, rings, or other similar methods.

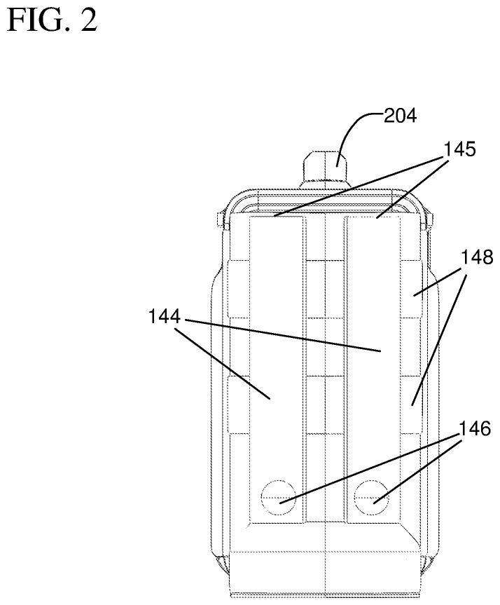

For ease of access and security, the pouch can also be configured to be attachable to various outerwear or other apparel such as backpacks. As depicted in FIG. 2, the pouch can, in some instances, comprise straps 144 and/or other features configured such that the pouch can be releasably coupled to modular lightweight load-carrying equipment (MOLLE). In this example, the straps 144 are fixedly attached at one side 145 (the top) and are fastened by a releasable fastener 146 at the other side (the bottom). As shown in FIG. 2, in one example the fastener 146 may be a snap fastener. In other examples the fastener may be hook and loop, a side release buckle, or any other suitable fastener. In addition to the straps 144, the pouch may also have horizontal webbing 148 to assist in securely attaching the pouch. In lieu of or in addition to MOLLE, the pouch can be secured to various other types of connection systems, apparel, bags/packs, etc.

The battery 200 serves to provide a backup energy supply for an electronic device. The battery 200 can comprise a wired or wireless charging unit for charging the electronic device. The battery 200 can have a plurality of ports for connecting a variety of inputs and outputs. As shown in FIG. 5, in one example these inputs and outputs can consist of two outputs and one input. The ports can, for example, be used to connect the battery to one or more other devices and/or charging cords. In some examples, the battery input ports may comprise a USB-C and or a micro USB port. In other examples, the battery can be charged using a wired connector. As shown in FIG. 8, in some examples, this wired connector is a USB-C connector and the battery 200 has a USB-C port 210.

For prolonged periods in the field there may be a need to charge the battery when there is not access to conventional sources of electricity. Solar power provides a means for charging the battery even when there is not an electrical outlet available. In some examples, the battery can be charged via solar power and has one or more solar panels 202 on the outward facing surface, as shown in FIG. 7.

The battery 200 may have a mechanism to power it off when not in use to save power. Referring to FIG. 4, in some examples, the battery may have a battery power button 208. In other examples the mechanism may be a switch, sensor, or other similar mechanism.

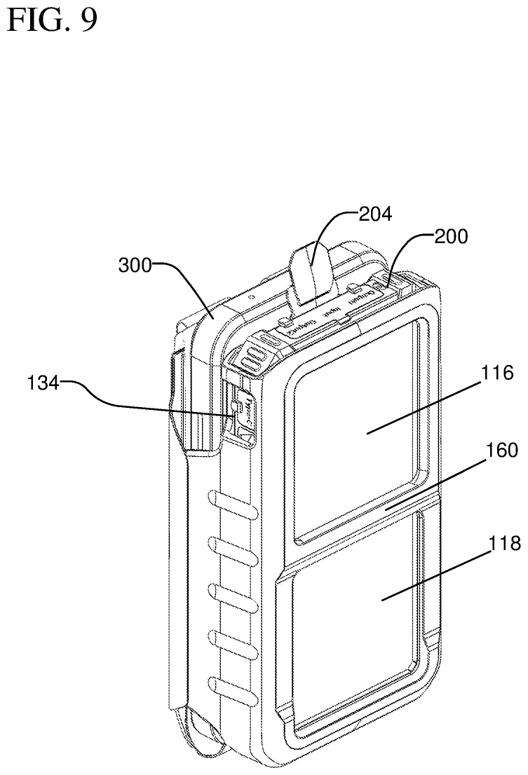

There may be a need for rapid, easy, and tool-less replacement of the battery 200 in the field. Referring to FIG. 9, the battery can comprise a mechanism coupled thereto to enable the user to replace the battery relatively easily. In one example, this mechanism can be a pull tab 204 which can, for example, be used to remove the battery from within the battery holding portion 110 of the pouch 100. In some examples the pull tab 204 can comprise a fabric tab. In other examples the pull tab can be made of various other materials such as metal or plastic. In still other examples the mechanism used can comprise a loop, ring, or other similar mechanism in place of a pull tab.

Referring to FIG. 6, in some instances the battery 200 can have a flashlight on the outer surface of the battery. The flashlight 206 may be configured to have different shapes, colors, or one or more modes of operation. In some instances, the flashlight is rectangular with rounded edges. In some examples the light of the flashlight may be white, red, blue, green, and/or any other suitable color. In the example with red light, the red light is selected to provides adequate light for nighttime operations while still preserving natural night vision. In some examples the flashlight may also have several different modes of operation, these modes may include but are not limited to steady, strobing, and/or a Morse code SOS signal

Referring again to FIG. 7, in some examples, the outside surfaces of the battery can have one or more friction enhancing elements 214. These friction enhancing elements 214 are configured to improve the user's grip on the battery 200. In the depicted example the friction enhancing elements 214 are a plurality of recesses 216 and projections 218. However, in other examples, the shape may vary and/or instead of recesses the friction enhancing elements 214 may be projections. Other friction enhancing elements are also possible, such as surface texturization.

The case 300 can be any of a variety of different commercially available protective cases for electronic devices. The case may vary in size and shape corresponding to the specific portable electronic device in use. The case 300 and can be constructed of a rigid or semi-rigid material. The case 300 can be formed of various materials, including polymeric materials. In one example, the case 300 is made of polycarbonate (PC). In other examples the phone case may be made of other materials or a combination of materials such as silicone, leather, carbon fiber, and/or other materials.

In view of the many possible examples to which the principles of the disclosure may be applied, it should be recognized that the illustrated examples should not be taken as limiting the scope of the disclosure.

1. A pouch for a portable electronic device, comprising:
an adjustable receptacle for receiving the portable electronic device, wherein the adjustable receptacle comprises a plurality of flaps;
wherein the plurality of flaps comprises, one or more side flaps, a main flap, and a retention flap;
wherein the main flap comprises a first segment and a second segment and the second segment is pivotably attached to the first segment; and
wherein moving the adjustable flaps relative to each other changes a size of the adjustable receptacle.

2. The pouch of claim 1, further comprising a battery holding portion configured for receiving a battery therein.

3. The pouch of claim 2, wherein the battery holding portion comprises a retention feature therein configured for securing an external battery therein.

4. The pouch of claim 2, wherein the pouch comprises a panel with a wireless charging locator.

5. The pouch of claim 1, wherein the pouch further comprises one or more straps capable of being connected to an external substrate.

6. The pouch of claim 2, wherein the battery holding portion contains outward facing windows.

7. A pouch for a portable electronic device, comprising:
an adjustable receptacle for receiving the portable electronic device, wherein the adjustable receptacle comprises a plurality of flaps adjustable coupled together, and wherein moving the adjustable flaps relative to each other changes a size of the adjustable receptacle and/or a retention force on the portable electronic device.

8. The pouch of claim 7, further comprising a battery holding portion configured for receiving a battery therein.

9. The pouch of claim 8, wherein the battery holding portion comprises a retention feature therein configured for securing an external battery therein.

10. The pouch of claim 8, wherein the pouch comprises a panel with a wireless charging locator.

11. The pouch of claim 8, wherein the pouch comprises a panel with a battery level window.

12. The pouch of claim 8, wherein the battery holding portion contains outward facing windows.

13. An assembly comprising:
a pouch comprising an adjustable receptacle and a battery holding portion, wherein the adjustable receptacle is configured for receiving a portable electronic device; and
an external battery configured to be releasably secured within the battery holding portion of the pouch.

14. The assembly of claim 13, further comprising a case for a portable electronic device.

15. The assembly of claim 13, wherein the external battery comprises a pull tab configured for removing the external battery from the pouch.

16. The assembly of claim 13, further comprising a portable electronic device.

17. The assembly of claim 16, wherein the portable electronic device is a mobile phone.

18. The assembly of claim 13, wherein:
the adjustable receptacle comprises a plurality of flaps; and
the plurality of flaps comprises, one or more side flaps, a main flap, and a retention flap.

19. The assembly of claim 18, wherein the battery holding portion of the pouch comprises a projection configured for mating with a recess of the external battery.

20. The assembly of claim 19, wherein the pouch comprises a panel with a wireless charging locator.
